(19) United States
(12) Patent Application Publication
(10) Pub. No.: US 2011/0064380 A1
(43) Pub. Date: Mar. 17, 2011

(54) CONTENT REPRODUCING APPARATUS, CONTENT EDITING APPARATUS, SERVER APPARATUS, CONTENT REPRODUCING SYSTEM, CONTENT EDITING SYSTEM, CONTENT REPRODUCING METHOD, AND CONTENT EDITING METHOD

(75) Inventor: Jiro Kiyama, Osaka (JP)

(73) Assignee: SHARP KABUSHIKI KAISHA, Osaka (JP)

(21) Appl. No.: 12/993,658

(22) PCT Filed: Mar. 11, 2009
(86) PCT No.: PCT/JP2009/054619

§ 371 Date: Nov. 19, 2010

(30) Foreign Application Priority Data
May 23, 2008 (JP) 2008-135327
Jun. 13, 2008 (JP) 2008-155093

(51) Int. Cl. H04N 9/80; H04N 5/91

(52) U.S. Cl. 386/239; 709/203; 386/E05.003

(57) ABSTRACT

The present invention provides a content reproducing/editing system and a content reproducing/editing apparatus for displaying to a user that other users cannot view associated information even if the associated information is added to content data. Further, it provides a content reproducing/editing system and a content reproducing/editing apparatus for displaying to the user that, when performing editing to delete a segment of the content data to which the associated information is added, the associated information is added to the segment to be deleted. It is displayed to a user X that, even if a comment is added, other users Y, Z, and the like cannot view the comment and it is checked whether the comment is added. It is displayed to the user X that, when performing editing to delete a specified segment, the comment is added to the segment and it is checked whether the deletion is executed.

### TECHNICAL FIELD

The present invention relates to a content reproducing/editing system and apparatus capable of reproducing/editing content data, and more particularly, to a content reproducing system and apparatus capable of adding relevant information (comment) relating to content data to the content data and a content editing system and apparatus capable of editing content data having relevant information relating to the content data added thereto.

### BACKGROUND OF THE INVENTION

A system has hitherto been proposed that enables a plurality of users reproducing content data distributed in streaming to add relevant information relating to the content data and to view the relevant information (see Patent Document 1). The users can communicate based on the content data with each other by utilizing the system.

According to the improvement in performance of PC and the development of P2P (Peer to Peer), a system has been proposed that records the same content data in each PC of individual users (X to Z) to enable each user to add relevant information at any time point of the content data recorded in PC of the user. The system transmits the added relevant information to a server apparatus.

A user X can view the relevant information added by other users Y and Z by downloading information relating to the relevant information from the server apparatus to the PC of the user X and reproducing content data at the time when the relevant information is added.

An editing processing for deleting a portion of the content data recorded in the HDD, for example, a portion that has already been reproduced is frequently executed in order to reduce a capacity used in a recording device such as HDD that records the content data.

However, for example, in the PC of the user X if a segment of the content data including the relevant information added by the user Y and the user Z at certain time points is deleted, the user X cannot view the relevant information because the segment of the content data can no longer be reproduced.

Patent Document 1: Japanese Laid-Open Patent Publication No. 2006-155384

### DISCLOSURE OF THE INVENTION

### Problems to be Solved by the Invention

It is assumed that a user X reproduces content data recorded in PC and adds relevant information at a certain time point.

In this case, if none of the content data is recorded or a segment including the time point of the content data is not recorded in PCs of users Y and Z, the users Y and Z never view the relevant information added by the user X.

Therefore, the users X, Y, and Z are not able to communicate based on the relevant information to be added by the user X with each other, and therefore the meaning of adding the relevant information is little.

It is then assumed that relevant information of the users Y and Z is added at a certain time point of content recorded in the PC of the user X and that the user X edits the content to delete a segment including the time point.

In such a case, if the user X deletes the segment without being aware of the fact that the relevant information is added to the segment of the content, it becomes impossible to view the relevant information as described above.

The present invention was conceived in view of the situations and the object of the present invention is to provide a content reproducing/editing system and apparatus which display the fact to a user when other users adding are not able to view the relevant information added to content date and to provide a content reproducing/editing system and apparatus which display the fact to a user that relevant information is added to a segment to be deleted if edition of deleting a corresponding segment of content data with relevant information added is performed.

### Means for Solving the Problems

A first technical means of the present invention is a content reproducing apparatus in a content reproducing system configured by connecting a server apparatus and a plurality of content reproducing apparatuses performing synchronous reproduction of content data and relevant information related to the content data to a network, comprising: a portion that receives viewable segment information transmitted from the server apparatus, the viewable segment information indicating a viewable content reproduction position in another content reproducing apparatus for content data recorded in the another content reproducing apparatus; a relevant information adding portion that when adding relevant information to recorded content data at a predetermined position, adds relevant information based on specified addition segment information corresponding to the position; and an assessing portion that assesses appropriateness of adding the relevant information to the content data at the position based on the specified addition segment information and the received viewable segment information.

A second technical means is the content reproducing apparatus as defined in the first technical means, comprising a portion that transmits viewable segment information indicative of a viewable content reproduction position of recorded content data to the server apparatus.

A third technical means is the content reproducing apparatus as defined in the first technical means, wherein the addition of the relevant information is performed if assessed as appropriate, and wherein a screen is displayed that inquires whether it is necessary to add the relevant information if assessed as inappropriate.

A fourth technical means is the content reproducing apparatus as defined in the first technical means, wherein if assessed as appropriate, alternative segment information is retrieved that includes viewable position information of the recorded content data assessed appropriate for adding the relevant information based on the received viewable segment information.

A fifth technical means is the content reproducing apparatus as defined in the fourth technical means, wherein the retrieved alternative segment information is displayed.

A sixth technical means is the content reproducing apparatus as defined in the fourth technical means, wherein based on the retrieved alternative segment information, the relevant information is added by relating to the alternative segment information.

A seventh technical means is the content reproducing apparatus as defined in the first technical means, wherein the viewable segment information includes user ID information that identifies a user of a content reproducing apparatus with the viewable segment information set and wherein the appropriateness is assessed based on the user ID information.

An eighth technical means is a content editing apparatus in a content reproducing system configured by connecting a server apparatus and a plurality of content reproducing apparatuses reproducing content data to a network, comprising: an editing portion that edits content data based on edition segment information specified when editing the content data recorded in the content editing apparatus; a portion that receives relevant information addition segment information specified when relevant information is added to content data recorded in another content reproducing apparatus and transmitted from the server apparatus; and a portion that assesses appropriateness of editing the content data based on the received relevant information addition segment information and the edition segment information specified when editing content data recorded in the content editing apparatus.

A ninth technical means is the content editing apparatus as defined in the eighth technical means, comprising a portion that transmits relevant information addition segment information specified when adding relevant information to the content data to the server apparatus.

A tenth technical means is the content editing apparatus as defined in the eighth technical means, wherein the editing includes a skip reproduction processing of the content data, a deleting processing, and processing for adding continuation content data to the content data.

An eleventh technical means is the content editing apparatus as defined in the eighth technical means, wherein the editing is performed if assessed as appropriate, and wherein a screen is displayed that inquires whether it is necessary to perform the editing if assessed as inappropriate.

A twelfth technical means is the content editing apparatus as defined in the eighth technical means, wherein if assessed as appropriate, alternative segment information that includes position information of the recorded content data assessed appropriate for performing the editing is retrieved based on the received relevant information segment information.

A thirteenth technical means is the content editing apparatus as defined in the twelfth technical means, wherein the retrieved alternative segment information is displayed.

A fourteenth technical means is the content editing apparatus as defined in the twelfth technical means, wherein based on the retrieved alternative segment information, the editing is performed by relating to the alternative segment information.

A fifteenth technical means is the content editing apparatus as defined in the eighth technical means, wherein when performing a skip reproduction editing of content data, the editing portion stores specified edition segment information, assesses appropriateness of canceling the skip reproduction editing of the content data based on the received relevant information addition segment information and the stored edition segment information, and erases the stored edition segment information if assessed as appropriate.

A sixteenth technical means is the content editing apparatus as defined in the eighth technical means, wherein the relevant information includes at least one of evaluation information of importance of the relevant information, user ID information identifying a user adding the relevant information, and time information of the addition of the relevant information, and wherein the appropriateness is assessed based on any one of the pieces of the information.

A seventeenth technical means is a server apparatus in a content reproducing system configured by connecting the server apparatus and a plurality of content reproducing apparatuses performing synchronous reproduction of content data and relevant information related to the content data to a network, comprising: a portion that receives viewable segment information indicating a viewable content reproduction position of recorded content data transmitted from the content reproducing apparatuses, and/or a portion that receives the relevant information and relevant information addition segment information specified when the relevant information is added if relevant information is added to the content data, and recording the received viewable segment information, the relevant information, and the addition segment information and transmitting the viewable segment information, the relevant information, and the addition segment information in accordance with a request from the content reproducing apparatuses.

An eighteenth technical means is a server apparatus in a content editing system configured by connecting the server apparatus and a plurality of content editing apparatuses editing content data to a network, comprising: a portion that receives relevant information transmitted from the content editing apparatuses when relevant information is added to the content data in the content editing apparatuses and relevant information addition segment information specified when the relevant information is added, and recording the received relevant information and the addition segment information and transmitting the relevant information and the addition segment information in accordance with a request from the content editing apparatuses.

A nineteenth technical means is a content reproducing system consisting of the content reproducing apparatuses as defined in the first technical means.

A twentieth technical means is a content editing system consisting of the content editing apparatuses as defined in the eighth technical means.

A twenty first technical means is a content reproducing method executed by a content reproducing apparatus in a content reproducing system configured by connecting a server apparatus and a plurality of content reproducing apparatuses performing synchronous reproduction of content data and relevant information related to the content data to a network, comprising the steps of: receiving viewable segment information transmitted from the server apparatus, wherein the viewable segment information indicates a viewable content reproduction position in another content reproducing apparatus for content data recorded in the another content reproducing apparatus; adding relevant information based on specified addition segment information when adding relevant information to recorded content data at a predetermined position, wherein the addition segment information corresponds to the position; and assessing appropriateness of adding the relevant information to the content data at the position based on the specified addition segment information and the received viewable segment information.

A twenty second technical means is a content editing method executed by a content editing apparatus in a content reproducing system configured by connecting a server apparatus and a plurality of content reproducing apparatuses reproducing content data to a network, comprising the steps of: receiving relevant information addition segment information transmitted from the server apparatus, wherein the relevant information addition segment information is specified when relevant information is added to content data recorded in another content reproducing apparatus; and assessing appropriateness of editing the content data based on the received relevant information addition segment information and edition segment information specified when editing content data recorded in the content editing apparatus.

A twenty third technical means is a program operable to drive a computer to execute the content reproducing method as defined in the twenty first technical means.

A twenty fourth technical means is a program operable to drive a computer to execute the content editing method as defined in the twenty second technical means.

A twenty fifth technical means is a recording medium having the program as defined in the twenty third technical means recorded thereon in a computer readable manner.

A twenty sixth technical means is the server apparatus as defined in the seventeenth technical means.

A twenty seventh technical means is the server apparatus as defined in the eighteenth technical means.

A twenty eighth technical means is a recording medium having the program as defined in the twenty fourth technical means recorded thereon in a computer readable manner.

### EFFECT OF THE INVENTION

The present invention is able to provide a content data reproducing/editing system and apparatus that make communication between users actively by adding relevant data to content data and that causes no trouble in the communication due to editing. As a result, the user's convenience is improved.

### BRIEF DESCRIPTION OF THE DRAWINGS

FIG. 1 is a diagram showing the outline of the present invention.

FIG. 2 is a block diagram for explaining functions of a server apparatus.

FIG. 3 is a diagram of a configuration of a database.

FIG. 4 is a diagram of an exemplary configuration of a database managed by a database control portion.

FIG. 5 is a functional block diagram of one exemplary configuration of a content reproducing apparatus (content editing apparatus) of this embodiment.

FIG. 6 is a flow diagram for explaining a process when a user gives a content reproducing instruction.

FIG. 7 is a flow diagram for explaining a process when an instruction for adding relevant information is given while AV data is reproduced.

FIG. 8 is a flow diagram for explaining a process when an instruction is given for editing AV data while the AV data is reproduced.

FIG. 9 is a functional block diagram of another exemplary configuration of the content reproducing apparatus of this embodiment.

FIG. 10 is a flow diagram for explaining another process when a user gives a content reproducing instruction.

### EXPLANATION OF REFERENCE NUMERALS

1 (1x to 1z) . . . content reproducing apparatus (content editing apparatus); 2 . . . content data; 100 . . . general control portion; 100a . . . appropriateness assessing portion; 110 . . . UI portion, 120 . . . viewable segment information managing portion; 130 . . . relevant information adding portion; 140 . . . relevant information managing portion; 150 . . . relevant information drawing portion; 160 . . . AV data editing portion; 170 . . . AV data managing portion; 180 . . . AV data decoding portion; 190 . . . combining portion; 200 . . . communicating portion; 210 . . . AV data recording portion; 3 . . . server apparatus; 31 . . . content information recording portion; 32 . . . relevant information recording portion; 33 . . . viewable segment information recording portion; 34 . . . AV data recording portion; 35 . . . database control portion; 36 . . . control portion; 37 . . . communicating portion; 51 . . . entity “content”; 52 . . . entity “viewable segment information”; 53 . . . entity “relevant information”; and 54 . . . entity “AV data”.

### PREFERRED EMBODIMENT OF THE INVENTION

### Summary of the Invention

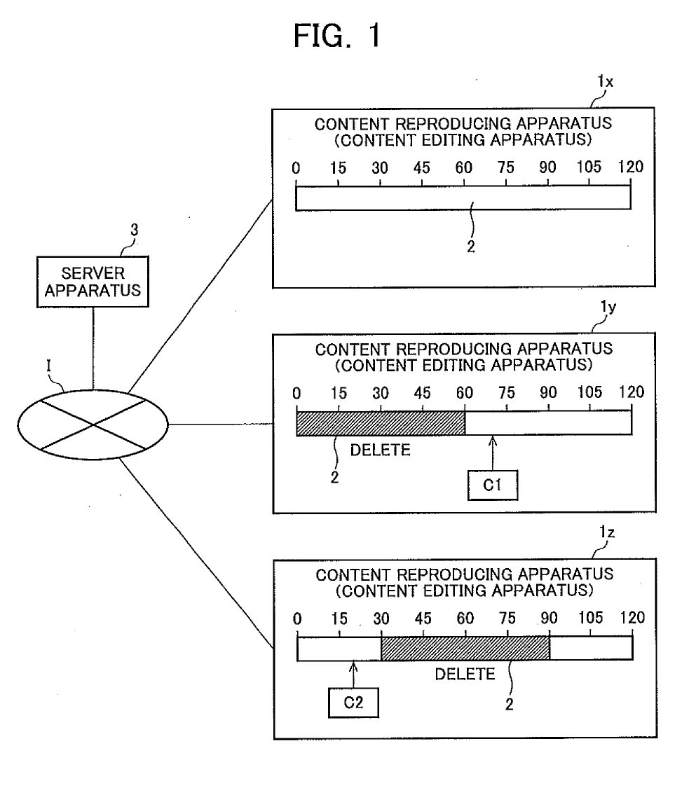

FIG. 1 is a diagram showing the outline of the present invention.

1 (1x, 1y, 1z) denotes a content reproducing apparatus (content editing apparatus) according to the present invention and the apparatus 1 records content data (AV data) 2 such as moving image data.

The content data 2 is a 120-minute serial drama, for example, and is downloaded and recorded in the content reproducing apparatuses (1x to 1z) from an image distribution server 3, etc., connected to the content reproducing apparatuses 1. In this way, users X, Y, and Z share the content data 2.

The users are able to add relevant information (comment) to the content data 2.

Although the user X adds no relevant information to the downloaded 120-minute content data 2, it is indicated that the user Y adds relevant information C1 at the time point of 70 minutes from the start of the content data 2 and that the user Z adds relevant information C2 at the time point of 20 minutes from the start of the content data 2.

Pieces of information related to the relevant information added to the content data 2 by the users, for example, information related to a content data segment with the relevant information added and details of the relevant information are transmitted and recorded in the server apparatus 3 connected to the content reproducing apparatus 1 via an Internet I as described later.

A content reproducing system is configured by connecting to a network the server apparatus 3 and a plurality of the content reproducing apparatuses 1 that perform synchronous reproduction (edit) of content data and relevant information related to the content data (the internet I).

If a user downloads relevant information recorded in the server apparatus 3 to the content reproducing apparatus 1 and reproduces a content data segment with the relevant information added, the user can browse details of not only the relevant information added by the user but also the relevant information added by other users.

In FIG. 1, for example, if the user X reproduces the content data 2 recorded in the content reproducing apparatus 1x at the time point of 70 minutes from the start of the content, the user X can view the relevant information C1 added to the content by the user Y at the time point of 70 minutes (synchronous reproduction).

The downloading of the relevant information is executed at various timings such as at the start of reproduction of the content data 2.

The users can edit the content data 2 recorded in the content reproducing apparatuses 1. In this case, the content reproducing apparatuses 1 have a content data editing function.

The editing means deleting (cutting) a certain segment of the recorded content data 2, for example, a CM segment and a segment already reproduced by a user, setting skip reproduction of the segment, and further adding a segment to the content data 2.

In FIG. 1, although no editing is performed for the content data 2 recorded in the content reproducing apparatus 1x of the user X, it is indicated that a segment from 0 to 60 minutes from the start is deleted (a shaded area of FIG. 1) from the content data 2 recorded in the content reproducing apparatus 1y of the user Y and that a segment from 30 to 90 minutes from the start is deleted (a shaded area of FIG. 1) from the content data 2 recorded in the content reproducing apparatus 1z of the user Z.

As described above, the absence of editing of contents and the segment information of the deletion are transmitted and recorded into the server apparatus 3 described later.

It is assumed in the state described above that the user X reproduces the content data 2 recorded in the content reproducing apparatus 1x in attempting to add relevant information at the time point of 35 minutes from the start, for example. The contents in the segments including the 35-minute point are deleted from the content data 2 recorded in the content reproducing apparatuses 1y and 1z of other users Y and Z as described above.

If the user X adds the relevant information at the time point of 35 minutes from the start, the user Y and the user Z are unable to view the relevant information added by the user X since the segments of the contents corresponding to the time point are deleted from the content data 2 of the user Y and the content data 2 of the user Z.

Therefore, the present invention prompts confirmation of addition of the relevant information by performing display to indicate, for example, that other users Y, Z, etc., are unable to view the relevant information even if the relevant information is added at the time point.

It is then assumed that the user X performs the editing to delete a segment from 0 to 60 minutes from the start of the content data 2.

As described above, although the segment has the relevant information C2 added by the user Z, the relevant information can no longer be viewed if the deletion is executed.

Therefore, the present invention prompts confirmation of execution of the deletion by performing display to indicate, for example, that the relevant information C2 is added to the segment when the editing is performed to delete the segment.

### First Embodiment

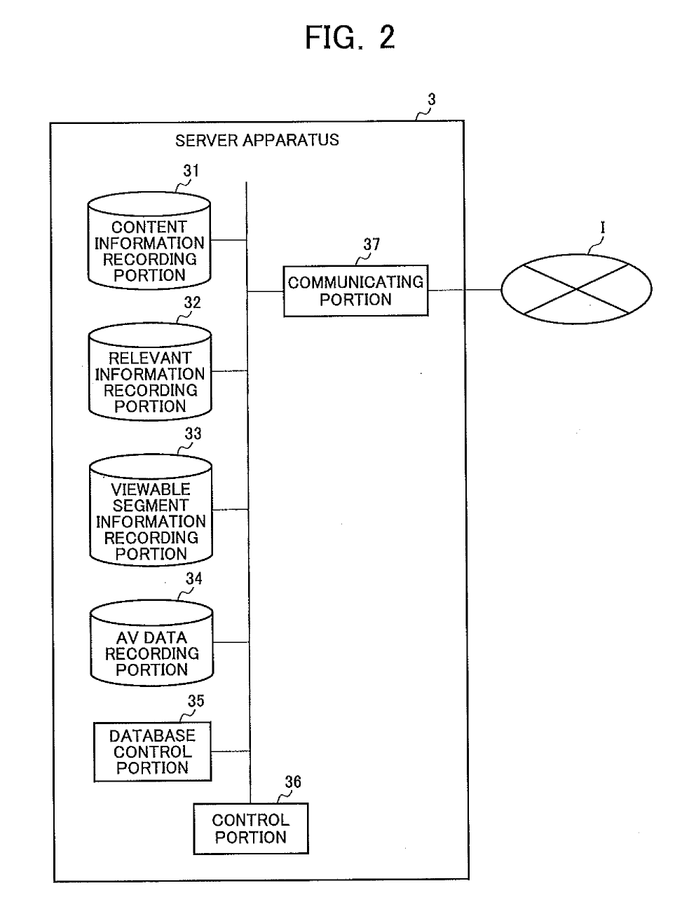

FIG. 2 is a block diagram for explaining functions of the server apparatus 3.

The server apparatus 3 is made up of a content information recording portion 31, a relevant information recording portion 32, a viewable segment information recording portion 33, an AV data (content data) recording portion 34, a database control portion 35, a control portion 36, and a communicating portion 37.

The database control portion 35 of the server apparatus generally manages information recorded in the content information recording portion 31, the relevant information recording portion 32, the viewable segment information recording portion 33, and the AV data recording portion 34 to make up a database.

The communicating portion 37 is responsible for the processing of communication with the content reproducing apparatuses 1, etc., executed via a network such as the Internet I and the control portion 36 controls the functional blocks.

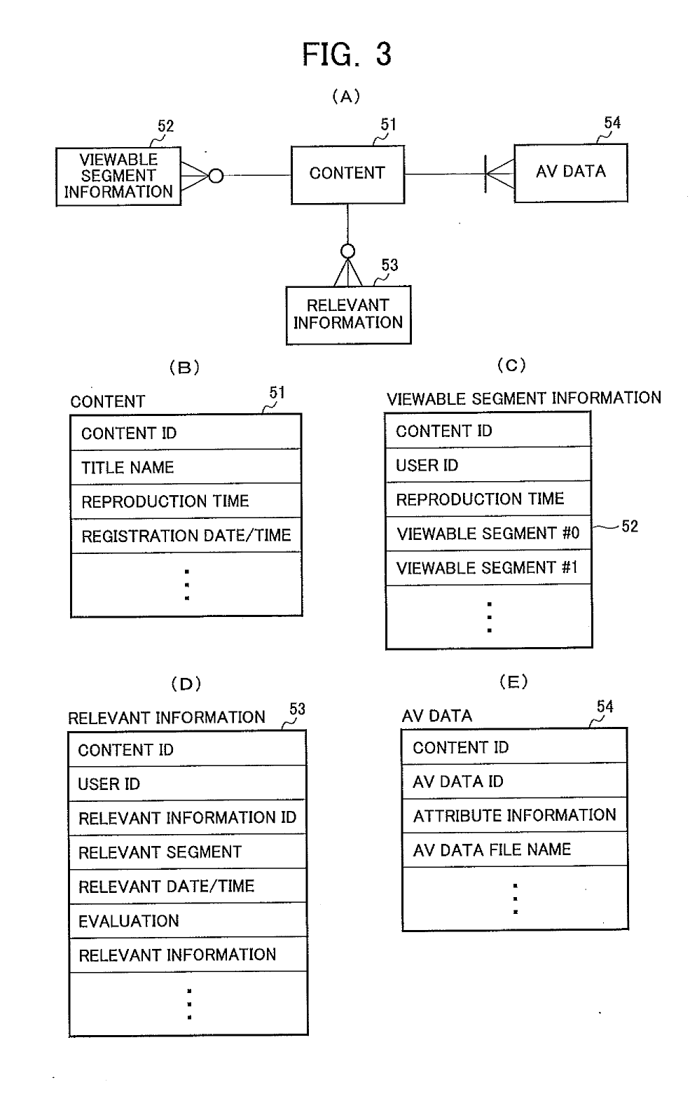

The configuration of the database is depicted in FIG. 3.

A relationship between entities (Entity is a group of data handled as a unit) making up this database will be described by using an ER diagram (Entity Relation Diagram) of FIG. 3(A).

An entity “content 51” represents a content corresponding to one unit of viewing, such as one drama or a sport program for one game and is correlated with zero or more entities “viewable segment information 52”, zero or more entities “relevant information 53”, and one or more entities “AV data 54”.

The entity “viewable segment information 52” corresponds to viewable segments of AV data recorded in the content reproducing apparatuses 1 of the users and is changed when the editing is performed.

The entity “relevant information 53” corresponds to relevant information (comment) added to the entity “AV data 54” of the entity “content 51”.

The entity “AV data 54” corresponds to actual AV data itself corresponding to the entity “content 51”, and data for managing the attribute information thereof.

The entities will then be described in detail.

FIG. 3(B) depicts a data schema of a table storing the entity “content 51”, including a content ID field, a title name field, a reproduction time field, and a registration date/time field. One record corresponds to one content made up of one or more AV data.

A content ID is a unique ID for identifying a content. The title name field, the reproduction time field, and the registration date/time field correspond to a title name, a reproduction time, and registration date/time, respectively, of the record. This table is stored in the content information recording portion 31.

FIG. 3(C) is a data schema of a table storing the entity “viewable segment information 52”, including a content ID field, a user ID field, a reproduction time field, and a variable number of viewable segment fields. One record corresponds to a viewable segment of content data (AV data) recorded in a content reproducing apparatus of a user identified by a user ID and related to a content identified by a content ID. The viewable segment corresponds to reproduction segments of a corresponding content and is represented by a sequence of reproduction segments. In the viewable segment field, a viewable segment of content data recorded in the content reproducing apparatus 1 is identified by a reproduction time from the beginning of the content, for example, and is stored as viewable segment information.

Exemplarily illustrating the case of FIG. 1, the viewable segment information corresponds to information indicating that a segment of 60 to 120 minutes from the start is viewable (reproducible) in the case of the content data recorded in the content reproducing apparatus 1y of the user Y. In the case of user Z, the viewable segment information corresponds to information indicating that segments of 0 to 30 minutes and 90 to 120 minutes from the start are viewable. This table is stored in the viewable segment information recording portion 33.

FIG. 3(D) is a data schema of a table storing the entity “relevant information 53”, including a content ID field, a user ID field, a relevant information ID field, a relevant segment field, a relevant date/time field, an evaluation field, and a relevant information field.

One record corresponds to relevant information identified by a relevant information ID and added by a user identified by a user ID to content data (AV data) related to a content identified by a content ID, and various pieces of attribute information thereof.

The related segment field stores a segment with relevant information added in content data (AV data) recorded in a content reproducing apparatus of a user identified by a user ID and related to a content identified by a content ID. In other words, the related segment field stores segment information (addition segment information) specified when relevant information is added to content data recorded in the content reproducing apparatus. Exemplarily illustrating the case of FIG. 1, the specified segment information indicates that the relevant information is added at the time point of 70 minutes from the start of the content data 2 for the user Y and that the relevant information is added at the time point of 20 minutes from the start of the content data 2 for the user Z.

The evaluation field and the relevant date/time field store user's evaluation of importance and the date/time of addition, respectively, related to relevant information identified by a relevant information ID. The relevant information is stored as text data indicative of details of the relevant information (comment) and a control symbol, etc., indicative of an output form. This table is stored in the relevant information recording portion 32.

FIG. 3(E) is a data schema of a table storing the entity “AV data 54”, including a content ID field, an AV data ID field, an attribute information field, and an AV data file name field. One record corresponds to one AV data (content data) making up a content identified by a content ID. AV data is identifiable by a content ID and the AV data ID field. The attribute information field stores attribute information of corresponding AV data. The AV data file name field indicates a file name of actual AV data itself. This table is stored in the AV data recording portion 34.

The entities are transmitted from the content reproducing apparatus 1 to the server apparatus 3 and stored in the recording portions (31 to 34).

The database control portion 35 of the server apparatus 3 integrates the entities into a database. In response to a query (retrieval request) using a content ID, a user ID, etc., as a key from the content reproducing apparatus 1, a record (entity) including a necessary information is retrieved and returned. In response to a request of addition/update/deletion of the relevant information or the viewable segment information from the content reproducing apparatus 1, the data base is updated in a consistent manner.

The communicating portion 37 of the server apparatus 3 acts as a portion that receives viewable segment information transmitted from the content reproducing apparatus 1 and indicative of information of a viewable segment of content data and/or as a portion that receives relevant information and addition segment information of the relevant information specified when the relevant information is added, if the relevant information is added to the content data.

The database control portion 35 records the viewable segment information received by the portion into the viewable segment information recording portion 33 and the relevant information (the addition segment information of the relevant information) into the relevant information recording portion 32 and transmits the viewable segment information and the relevant information (the addition segment information) in response to a request from the content reproducing apparatus.

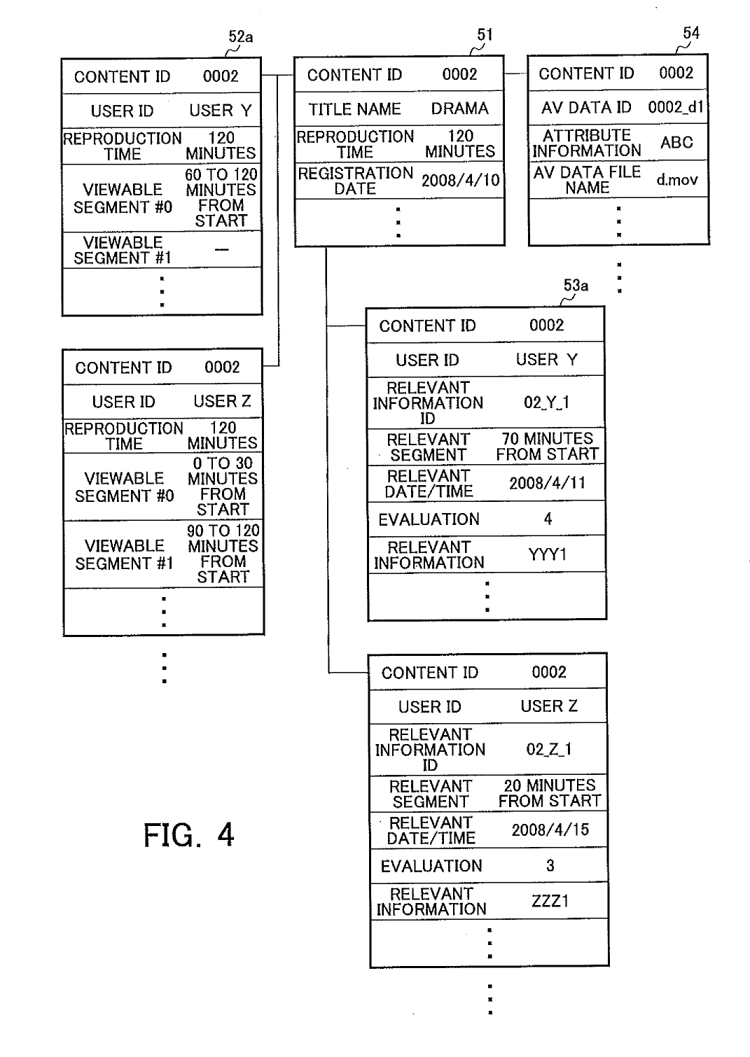

FIG. 4 is a diagram of an exemplary configuration of a database managed by the database control portion 35 of the server apparatus 3.

As depicted in FIG. 4, portions of the viewable segment information and the relevant information are configured as a database for the AV data (content data) recorded in the content reproducing apparatuses of the user Y and the user Z exemplarily illustrated in FIG. 1.

### <Configuration of Content Reproducing Apparatus>

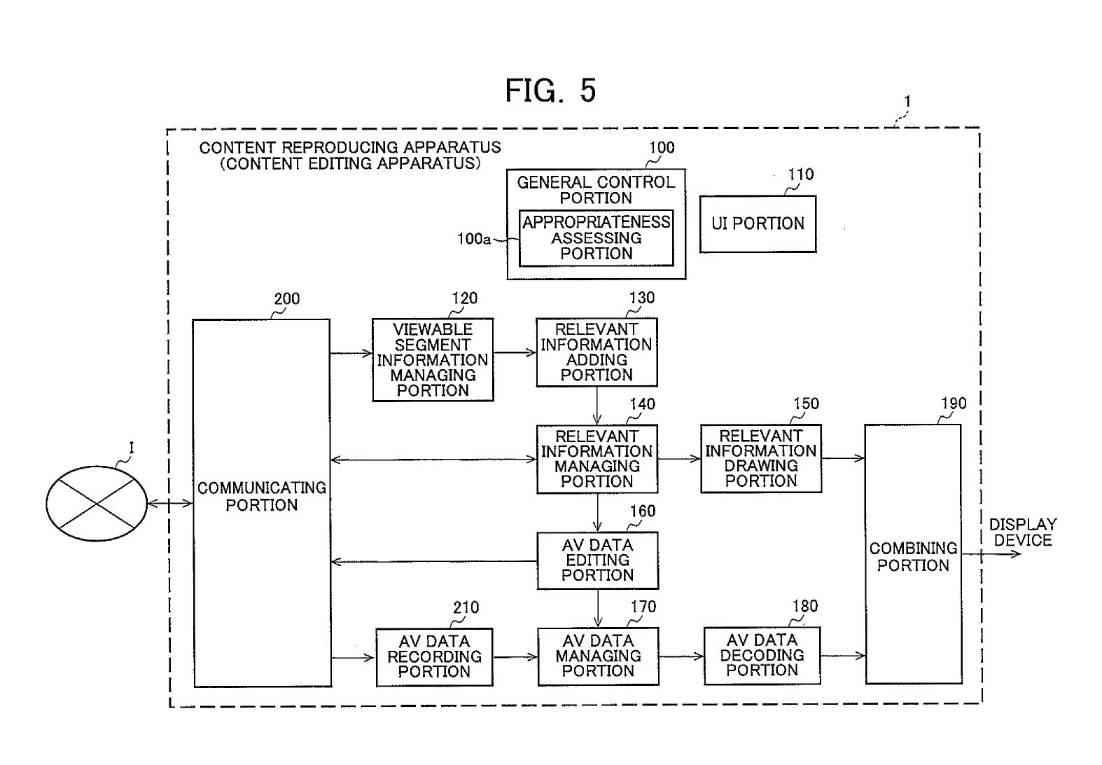

FIG. 5 is a functional block diagram of one exemplary configuration of the content reproducing apparatus of this embodiment.

The content reproducing apparatus 1 is an apparatus capable of recording/reproducing content data distributed through the server apparatus 3. A content data editing function can also be included. In this case, the content reproducing apparatus acts as a content editing apparatus.

As depicted in FIG. 5, the content reproducing apparatus 1 includes a general control portion 100, a appropriateness assessing portion 100a, a UI (User Interface) portion 110, a viewable segment information managing portion 120, a relevant information adding portion 130, a relevant information managing portion 140, a relevant information drawing portion 150, an AV data editing portion 160, an AV data managing portion 170, an AV data decoding portion 180, a combining portion 190, a communicating portion 200, and an AV data recording portion 210. The overview and relation of the processing portions will hereinafter be described.

The general control portion 100 is responsible for the general control and gives instructions based on various notifications from the processing portions.

The appropriateness assessing portion 100a acts as a portion that assesses appropriateness of adding relevant information at a given portion of content data and that assesses appropriateness of editing content data based on edition segment information specified at the time of editing of the content data.

The UI portion 110 accepts an operation from a user, notifies the general control portion 100, and displays OSD (On Screen Display) in accordance with an instruction from the general control portion 100 to perform the presentation of warning, confirmation, etc., to the user.

The communicating portion 200 is responsible for the processing of communication with the server apparatus 3 executed via a network such as the internet I.

The viewable segment information managing portion 120 acquires/retains the entity “viewable segment information 52” (FIG. 3(C)) from the server apparatus 3 through the communicating portion 200 in accordance with an instruction from the general control portion 100 and provides the information at the request from another processing portion.

The viewable segment information managing portion 120 and the communicating portion 200 acts as a portion that receives viewable segment information transmitted from the server apparatus 3 for content data recorded in another content reproducing apparatus.

The relevant information adding portion 130 acts as a portion that adds relevant information to content data when the relevant information input through the UI portion 110 is added to a given position of content data, based on specified addition segment information corresponding to the position. The relevant information adding portion 130 gives an instruction for addition of relevant information, etc., to the relevant information managing portion 140.

The relevant information managing portion 140 acquires/retains the entity “relevant information 53” (FIG. 3(D)) from the server apparatus 3 through the communicating portion 200 in accordance with an instruction from the general control portion 100 and provides the information at the request from another processing portion.

The relevant information managing portion 140 uploads (transmits) the relevant information, etc., added by the relevant information adding portion 130 to the server apparatus 3 through the communicating portion 200.

The relevant information managing portion 140 acts as a portion that transmits to the server apparatus 3 the addition segment information of relevant information specified when the relevant information is added to content data. The relevant information managing portion 140 also acts as a portion that receives the addition segment information of relevant information specified when the relevant information is added to content data recorded in another content reproducing apparatus and transmitted from the server apparatus 3.

Exemplarily illustrating the case of FIGS. 1 and 4, if the user Y inputs YYY1 indicative of details of relevant information at the time point of 70 minutes from the start of content data (AV data) identified by the content ID: 0002, an entity “relevant information 53a” with various pieces of information stored in the fields as depicted in FIG. 4 is generated and transmitted to the server apparatus 3.

The database control portion 35 of the server apparatus 3 receives the entity “relevant information 53a” and records the received entity “relevant information 53a” into the relevant information recording portion 32 to configure the database exemplarily illustrated in FIG. 4.

In synchronization with the decoding of the AV data by the AV data decoding portion 180, if relevant information is added to the decoded AV data, the relevant information drawing portion 150 acquires details of the relevant information from the relevant information managing portion 140 and converts them into graphic data and uncompressed audio data for transmission to the combining portion 190.

The AV data editing portion (editing portion) 160 edits the AV data through the AV data managing portion 170 based on edition segment information (edition information) specified through the UI portion 110 at the time of editing of the content data recorded in the content reproducing apparatus 1. The edition segment information indicates deletion of a segment of a portion of the AV data (e.g., deletion of CM), instructions such as skip reproduction, or segment information for performing deletion/skip reproduction/skip edition.

The AV data editing portion 160 manages the viewable segment information of the AV data during reproduction and requests the server apparatus 3 through the communicating portion 200 to update the viewable segment if a change is made in the viewable segment information of the content data by performing the editing.

The AV data editing portion 160 acts as a portion that transmits the viewable segment information indicative of a reproduction position of viewable content of the content data to the server apparatus.

Exemplarily illustrating the case of FIGS. 1 and 4, if editing is performed to delete a segment of 0 to 60 minutes from the start of the content data (120-minute serial drama) identified by the content ID: 0002 in the content reproducing apparatus 1y of the user Y, an entity “viewable segment information 52a” with various pieces of information stored in the fields as depicted in FIG. 4 is generated and transmitted to the server apparatus 3.

The database control portion 35 of the server apparatus 3 receives the entity “viewable segment information 52a” and records the received entity “viewable segment information 52a” into the viewable segment information recording portion 33 to configure the database exemplarily illustrated in FIG. 4.

The AV data managing portion 170 is a processing portion that stores/manages AV data. AV data is correlated and managed with a corresponding content ID and attribute information as exemplarily illustrated by the entity “AV data 54”, and a content ID can be specified to send AV data corresponding to the content ID to the AV data decoding portion 180 or to perform addition, change, return, etc., of the attribute information of the AV data.

The AV data decoding portion 180 reads and decodes AV data to send uncompressed AV data to the combining portion 190 through the AV data managing portion 170 in accordance with an instruction from the general control portion 100.

The combining portion 190 combines the uncompressed AV data sent from the AV data decoding portion 180 and the graphic data and the uncompressed audio data sent from the relevant information drawing portion 150 for output to a displaying apparatus not shown.

The AV data recording portion 210 receives the AV data distributed through the communicating portion 200 and the corresponding content ID and attribute information, which are recorded through the AV data managing portion 170.

The AV data recording portion 210 sets data in the field of the entity “AV data 54”, which is transmitted to the server apparatus 3.

At the time of recording, the AV data recording portion 210 registers all the segments of recorded AV data in the server apparatus 3 in a viewable manner through the AV data editing portion 160.

The content reproducing apparatus 1 includes a nonvolatile memory (not shown) to store a user ID, an ignored user list, and a favorite user list. The user ID is ID of a user using the content reproducing apparatus 1 and corresponds to the user ID (information) described above.

The ignored user list is a list of IDs of users who the user using the content reproducing apparatus 1 wants to ignore when using this system, and is used in a manner such that the relevant information created by users having IDs included in this list is not displayed as described later.

The favorite user list is a list of IDs of favorite users such as friends when the user using the content reproducing apparatus 1 uses this system, and is used to give warning, etc., at the time of addition of relevant information as described later.

The appropriateness assessing portion 100a acts as an assessing portion that, when relevant information is added to content data at a given position, assesses appropriateness of adding the relevant information at the portion of the content data based on the specified addition segment information corresponding to the position and the received viewable segment information (see FIG. 3(C)).

The appropriateness is also assessed based on the user ID information included in the received viewable segment information and identifying a user of the content reproducing apparatus with the viewable segment information set. This enables a certain user to view the relevant information to be added.

The appropriateness assessing portion 100a also acts as a portion that assesses appropriateness of editing content data based on the addition segment information (see FIG. 3(D)) of the received relevant information and the edition segment information specified at the time of editing of the content data.

The appropriateness is assessed based on anyone of the evaluation information of the importance of the relevant information, the user ID information identifying the user adding the relevant information, and the time information of the addition of the relevant information at least included in the received relevant information.

This enables the editing to be performed such that highly important relevant information can be viewed.

The general control portion 100 instructs the relevant information adding portion 130 to execute the addition of the relevant information if the appropriateness assessing portion 100a assesses that it is appropriate to add the relevant information, or executes the processing for displaying a screen for inquiring whether it is necessary to add the relevant information if it is assessed that the addition is inappropriate.

This prevents the relevant information from being added to a hardly-viewed segment and enables the relevant information added by a user to be easily viewed by many people.

The general control portion 100 instructs the AV data editing portion 160 to execute the editing if the appropriateness assessing portion 100a assesses that it is appropriate to perform the editing, or executes the processing for displaying a screen for inquiring whether it is necessary to perform the editing if it is assessed that the editing is inappropriate.

This prevents the relevant information created by another user from becoming unviewable due to the editing.

### <Reproduction Processing>

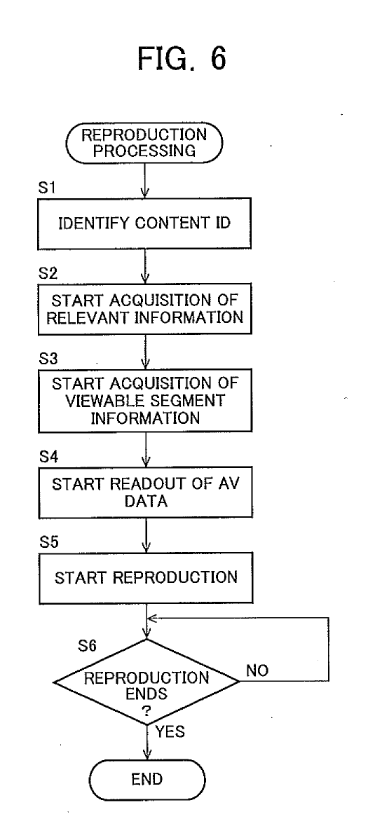

The processing in the general control portion 100 of the content reproducing apparatus 1 will be described in detail for the case that a user gives a content reproducing instruction with reference to FIG. 6.

First, a content ID of content data to be reproduced is identified (step S1). The identification of the content ID is performed, for example, by selecting a user from display of a content list with the UI portion 110.

The relevant information managing portion 140 is instructed to acquire the entity “relevant information 53” from the server apparatus 3 by using the identified content ID as a key (step S2). The viewable segment information managing portion 120 is instructed to acquire the entity “viewable segment information 52” from the server apparatus 3 by using the content ID as a key (step S3).

The AV data decoding portion 180 is instructed to start reading the AV data corresponding to the specified content ID (step S4).

When the decoding of the AV data is prepared and the acquisitions of the entity “viewable segment information 52” and the entity “relevant information 53” are completed, the AV data decoding portion 180 is instructed to start reproduction (step S5).

An editing processing and a relevant information adding processing described later are accepted during the reproduction and the reproduction is continued until the user gives a reproduction terminating instruction or the AV data decoding portion 180 gives a notification of arrival at the end of content (step S6).

### <Relevant Information Adding Processing>

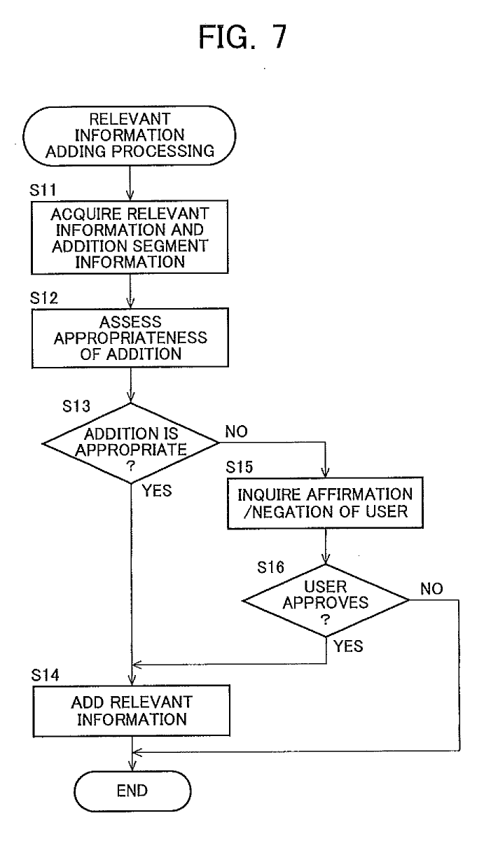

The processing in the general control portion 100 will be described for the case that an instruction for adding relevant information is given while AV data is reproduced with reference to FIG. 7. It is assumed that the entity “viewable segment information 52” and the entity “relevant information 53” are already acquired as described in FIG. 6.

First, the relevant information added by a user and the segment information (addition segment information) specified at the time of the addition are acquired (step S11). For example, if a user viewing the content data (AV data) identified by the content ID: 0002 adds the relevant information (comment) of XXX1 at the time point of 35 minutes from the start, the added relevant information is acquired as “XXX1” and the segment information specified at the time of the addition is acquired as information indicative of 35 minutes from the start.

The appropriateness assessing portion 100a assesses (determines) the appropriateness of addition the relevant information based on the segment information and the viewable segment information stored in the viewable segment field in the acquired entity “viewable segment information 52” (step S12).

The viewable segment information of other users related to the content data being reproduced is compared with (checked against) the specified segment information to assess the appropriateness of addition of the relevant information. Specifically, the addition is assessed to be appropriate if a rate of the number of users capable of viewing the segment identified by the segment information specified by the user to all the users of the content data is higher than a certain threshold value and to be inappropriate if the rate is lower than the threshold value. The user ID included in the entity “viewable segment information 52” is compared with the user ID registered in the favorite user list and, if favorite users cannot view the relevant information, the addition is assessed to be inappropriate.

If an ID of a user unable to view the segment is included in the favorite list, the addition is assessed to be inappropriate.

If the appropriateness assessing portion 100a assesses that the addition of the relevant information is appropriate (step S13/YES), the general control portion 100 instructs the relevant information adding portion 130 to add the relevant information to the specified segment (step S14). The relevant information managing portion 140 requests the server apparatus 3 to add this relevant information to the content through the communicating portion 200 after adding the user ID. Therefore, the entity “relevant information 53” including the newly added relevant information is transmitted to the server apparatus 3.

If the addition is assessed to be inappropriate (step S13/NO), a warning is given to indicate that the relevant information will viewed by few users and/or cannot be viewed by the users Y and Z registered in the favorite user list, and a screen is displayed to inquire whether it is necessary to add the relevant information (step S15).

If approved by the user (step S16/YES), the addition process described above is executed. If not approved (step S16/NO), the addition process is canceled.

If it is assessed that the addition of the relevant information is inappropriate, viewable segment information assessed appropriate for adding the relevant information may be retrieved as alternative segment information based on the viewable segment information. In the example described above, if it is assessed that the addition to the time point of 40 minutes from the start is appropriate while the time point of 30 minutes from the start is inappropriate, the time point of 40 minutes from the start is retrieved as the alternative segment information.

The retrieved alternative segment information may be displayed to add the relevant information in a manner corresponding to the alternative segment.

This enables the relevant information created by the user to be added at the time point easily viewed by many people.

### <Editing Processing>

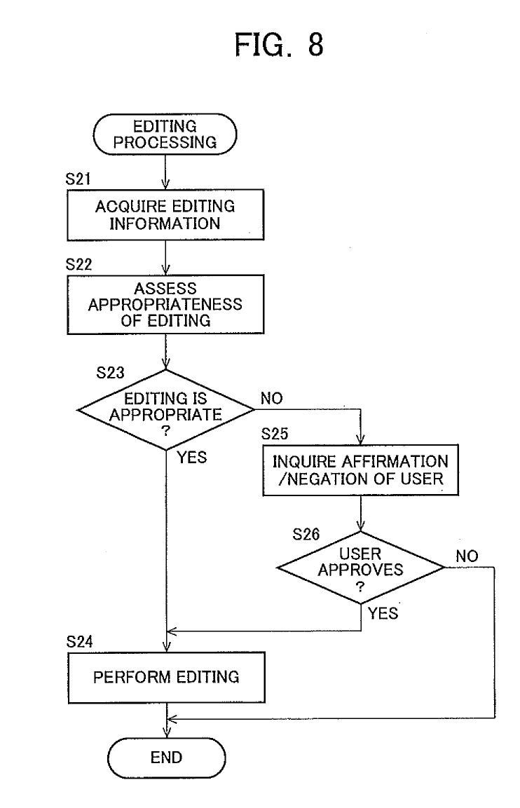

The processing in the general control portion 100 will be described for the case that an instruction is given for editing AV data while the AV data is reproduced with reference to FIG. 8.

As described above, the editing includes the skip reproduction processing of the content data, the deletion processing, and the processing for adding content data continued from the content data.

It is assumed that the entity “viewable segment information 52” and the entity “relevant information 53” are already acquired as described in FIG. 6.

First, the edition segment information (edition information) is acquired for content of interest of a user (step S21).

For example, if a user viewing the content data (AV data) identified by the content ID: 0002 performs the editing to delete a segment of 0 to 60 minutes from the start, the edition segment information is information indicating that the editing is performed to delete the segment of 0 to 60 minutes from the start.

The appropriateness assessing portion 100a assesses the appropriateness of editing the content data based on the segment information of the entity “relevant information 53” and the acquired edition segment information (step S22).

Specifically, the viewable segment of the content data changed by editing the content data based on the edition segment information is compared with (checked against) the additional segment information of the received relevant information to assess the appropriateness of editing the content data. If no useful relevant information is added to the segment of the content data becoming unviewable due to the editing for the deletion, the editing is assessed to be appropriate. Whether useful relevant information is added, i.e., the usefulness of the relevant information can be assessed by using the user ID and the relevant date/time of the received entity “relevant information 53” to give a higher score (evaluation) to those having a higher evaluation from users or a later relevant date/time (weighting of evaluation is executed) and to give a lower score if the user ID is a user ID included in the ignored user list (weighting of evaluation is not executed) and a higher score if the user ID is a user ID included in the favorite user list.

For example, if the editing is performed for deleting a segment of 0 to 60 minutes from the start, it is assumed that the relevant information is added to the segment. In this case, a score of evaluation is increased depending on a degree of an evaluation value for the relevant information. A difference is calculated between the date/time of execution of the editing and the data/time of addition of the relevant information and the score of evaluations is reduced as the difference increases. A score of evaluation is also determined for the user ID as described above.

The editing is assessed to be appropriate if a sum of the scores of determined evaluations is higher than a certain threshold and is assessed to be inappropriate if the sum is lower.

If it is assessed that the editing is appropriate (step S23/YES), the AV data editing portion 160 applies the edition segment information to the content data, i.e., performs the editing (step S24).

The AV data editing portion 160 updates the viewable segment information and makes a request through the communicating portion 200 to the server apparatus 3 for updating the viewable segment information of the content of the user of the content reproducing apparatus 1.

As a result, the entity “viewable segment information 52” including the viewable segment information is transmitted to the server apparatus 3.

If it is assessed that the editing is inappropriate (step S23/NO), a warning is given to the user to indicate that the useful relevant information becomes unviewable due to the execution of the editing and/or that the relevant information of the users Y and Z becomes unviewable and a screen is displayed to inquire whether it is necessary to perform the editing (step S25).

If approved by the user (step S26/YES), the editing processing based on the edition segment information described above is executed (step S24). If not approved (step S26/NO), the edition segment information is discarded.

If it is assessed that the editing is inappropriate, the segment information of the content data assessed appropriate for performing the editing can be retrieved as alternative segment information based on the segment information of the received relevant information. In the example described above, the segment information of the content data with no relevant information added is retrieved. Alternatively, a segment is retrieved that has the added relevant information having the score lower than the threshold value.

The retrieved segment may be displayed as the alternative segment information to perform the editing based on the retrieved alternative segment information.

This enables the user to know the segment not causing the deletion of the added relevant information, thereby ensuring better editing.

### <Variations>

With the above configuration, the relevant information is prevented from being added to a location viewed by few people. The useful relevant information is prevented from being made unviewable due to the editing. Many other variations and expansions of the present invention are conceivable as described below.

Although a query is made to a user about whether the addition is performed if it is assessed that the addition of the relevant information is inappropriate in this embodiment, the addition may simply be prohibited.

Although a query is made to a user about whether the editing is performed if it is assessed that the editing is inappropriate in this embodiment, the editing may simply be prohibited.

### Second Embodiment

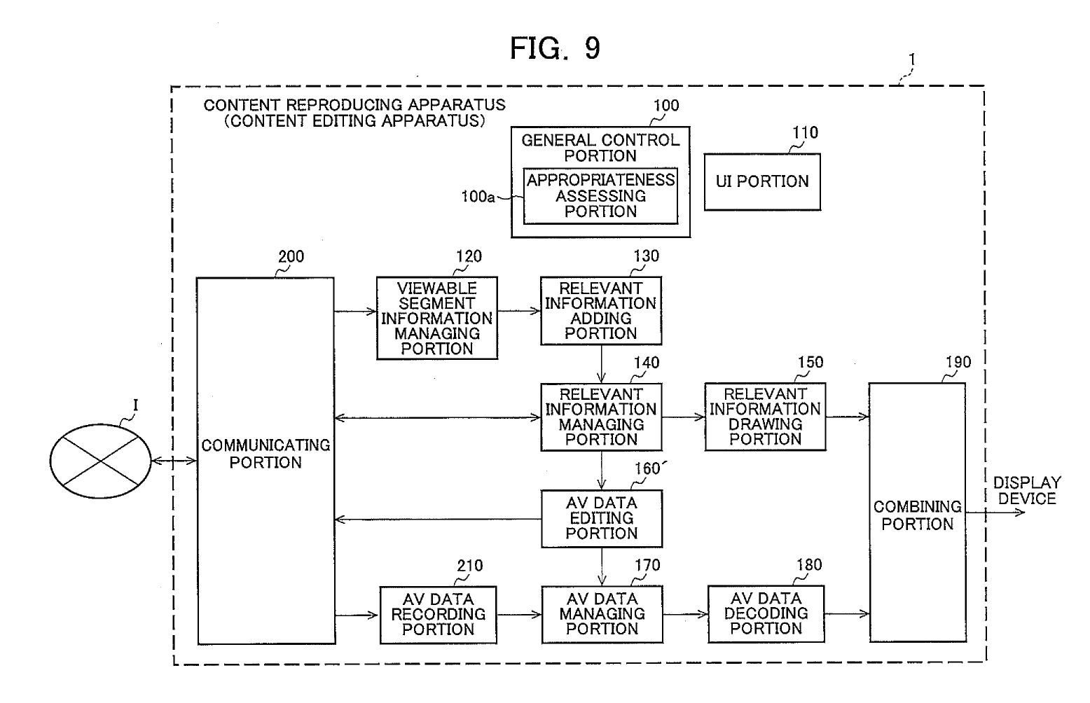

Another embodiment of the present invention will be described with reference to FIG. 9. For convenience of description, blocks having the same functions as the blocks described in the first embodiment will be denoted by the same reference numerals and will not be described. The terms defined in the first embodiment will be used in this embodiment in accordance with the definition unless otherwise stated.

### <Configuration of Content Reproducing Apparatus>

The configuration of the content reproducing apparatus 1 is in common with the first embodiment except the AV data editing portion 160. For the purpose of distinction, the AV data editing portion 160 of the second embodiment will be refer to an AV data editing portion 160′.

The AV data editing portion 160′ has an arrangement for canceling an already applied editing in addition to the behavior of the AV data editing portion 160. In the editing of deleting a segment of a portion of AV data (content data), only reference information of the AV data used at the time of reproduction is rewritten and the reference information before the editing is retained without deleting the AV data itself (which is hereinafter referred to as provisional deletion) and a provisionally deleted segment is skipped and not reproduced.

Specifically, when performing a skip reproduction editing of content data, the AV data editing portion 160′ (editing portion) stores the edition segment information specified by a user in a memory (not shown), assesses appropriateness of canceling the skip reproduction editing of the content data based on the addition segment information of the received relevant information and the stored edition segment information as described in the first embodiment, and erases the stored edition segment information if the canceling is assessed to be appropriate.

Since a recording capacity is limited, if a record size of AV data exceeds a certain threshold value, the AV data of contents recorded for a long time is actually deleted from a provisional deletion segment with less-useful relevant information added (which is hereinafter referred to as actual deletion). This processing is automatically performed in a time period while the AV data is not used by a user.

### <Reproduction Process>

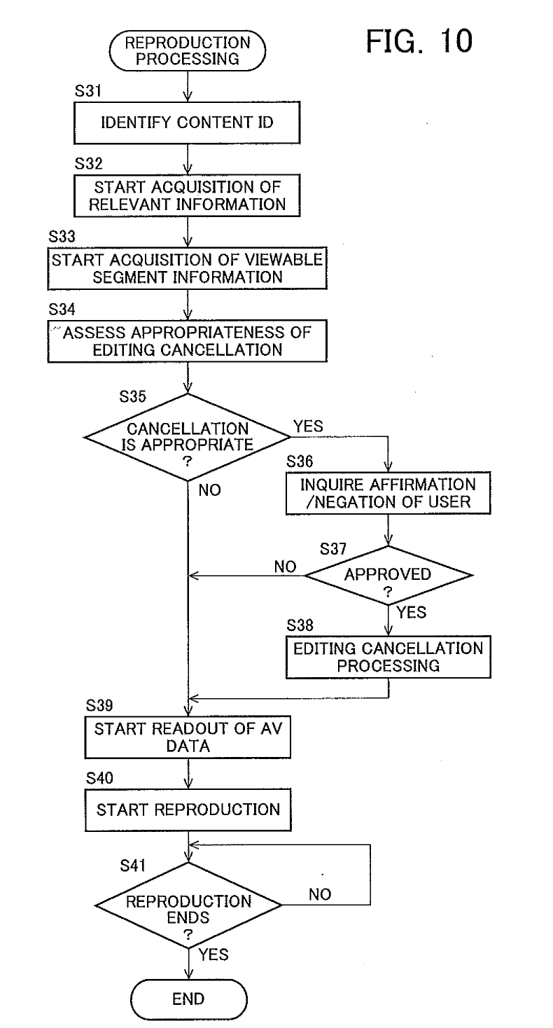

The processing in the general control portion 100 of the content reproducing apparatus 1 will be described for the case that a user gives a content reproducing instruction with reference to FIG. 10.

It is assumed that a user already gives an instruction for provisionally deleting a segment of a portion of content data and that the edition segment information including the provisional deletion segment information is stored in a memory not shown.

First, a content ID of content data to be reproduced is identified (step S31).

The general control portion 100 instructs the relevant information managing portion 140 to acquire the entity “relevant information 53” from the server apparatus 3 by using the identified content ID as a key (step S32). The general control portion 100 instructs the viewable segment information managing portion 120 to acquire the entity “viewable segment information 52” from the server apparatus 3 by using the content ID as a key (step S33).

Appropriateness of provisional deletion editing cancellation of the content data is assessed based on the segment information of the received entity “relevant information 53” and the edition segment information stored in the memory (step S34).

The provisional deletion editing cancellation of the content data means cancellation of execution of the actual deletion based on the edition segment information of provisional deletion stored in the memory.

When the appropriateness of editing for deleting a segment specified for the provisional deletion, if useful relevant information is added to the segment of the content data becoming unviewable due to the deletion editing, it is assessed that the editing cancellation is appropriate.

This assessment is the same as the assessment of appropriateness of the deletion editing described above and will not be described.

If it is assessed that the editing cancellation is appropriate (the execution of deletion is inappropriate) (step S35/YES), information is presented to a user to indicate that the cancellation of editing of the content makes useful relevant information viewable and/or makes the relevant information of the user Y and the user Z viewable and a query is made to the user about whether the editing is canceled (step S36). If approved by the user (step S37/YES), the AV data editing portion 160′ is instructed to perform the editing cancelation (step S38). In this case, since the provisional deletion segment is included in the readout at step S39, the useful relevant information is not missed out.

The general control portion 100 instructs the AV data decoding portion 180 to start reading the AV data corresponding to the specified content ID (step S39).

When the decoding of the AV data is prepared and the acquisitions of the entity “viewable segment information 52” and the entity “relevant information 53” are completed, the AV data decoding portion 180 is instructed to start reproduction (step S40).

An editing processing and a relevant information adding processing described later are accepted during the reproduction and the reproduction is continued until the user gives a reproduction terminating instruction through the UI portion 110 or the AV data decoding portion 180 gives a notification of arrival at the end of content (step S41).

If it is assessed that the editing cancellation is inappropriate (the deletion editing is appropriate) (step S35/NO) or if not approved by the user (step S37/NO), the process after step S39 is executed. In this case, the provisional deletion segment is skipped to perform readout and reproduction.

### <Variations>

With the above configuration, even when a segment of a portion of the content data is once provisionally deleted, if useful information is added to the segment, the actual deletion is not executed in accordance with subsequent assessment and the useful relevant information is not missed out. Many other variations and expansions of the present invention are conceivable as described below.

Although the deletion of a segment of a portion of content data is intended in this embodiment, the present invention is applicable to the case that all the segments of content data are deleted, i.e., the case that the contents are entirely deleted. Specifically, the usefulness of relevant information is periodically assessed for contents other than those to be reproduced and, if useful relevant information is added, a user may be notified by a content list screen, etc.

Although it is assumed that a user performs the editing while contents are reproduced, this is not a limitation of the present invention. For example, the present invention is obviously applicable to an apparatus and software that perform automatic editing based on features of content data itself (e.g., details of sounds and transitions of scenes) and metadata created by another user.

### <Complements Common to Embodiments>

Although only the editing in the time direction is mentioned in the embodiments, the present invention is also applicable to the editing in the spatial direction and the editing combining the time direction and the spatial direction. Although only the specification on the time axis is mentioned for the addition of relevant information, the present invention is also applicable to specification in an image display space and specification in a time space. This leads to a suggestion that the present invention is applicable to a trimming function and a masking function for contents when it is assumed that a system is capable of adding relevant information at an arbitrary position of still-image contents.

Although AV data (content data) is downloaded through a network in the embodiments, the AV data (content data) may obviously be distributed through broadcasting or provided from a recording medium such as DVD as long as a correlation with a content ID is achieved.

Although the relevant information, the viewable segment information, and the content information are centrally managed in the server apparatus 3 in the embodiments, it may be managed decentralizedly in individual reproducing apparatuses using the P2P technique (editing apparatuses). In this case, the individual reproducing apparatuses substantially act as the server apparatus of the embodiments.

Although the confirmation of affirmation/negation of a user is performed with screen display in the embodiments, this is not a limitation. For example, the inquiry to a user may obviously be performed with audio output or front panel display of the reproducing apparatus.

Although the content reproducing apparatus 1 having the AV data (content data) editing function, specifically, the AV data editing portion 160, has been described in the embodiments, the editing function may not be included.

The content reproducing apparatus 1 may have any form of a reproducing apparatus, such as PC (Personal Computer).

Lastly, the blocks of the content reproducing apparatus 1 may be made up of hardware logics or may be implemented with software by using a CPU as described below. The content reproducing apparatus 1 includes a CPU (central processing unit) that executes an instruction of a control program that implements functions, a ROM (read only memory) that stores the program, a RAM (random access memory) that deploys the program, a storage device (recording medium) such as a memory that stores the program and various data, etc.

The object of the present invention is achievable by supplying a portable terminal or a stationary apparatus with a recording medium that records a program code of a control program (an executable format program, an intermediate code program, or a source program) for the portable terminal or the stationary apparatus, i.e., software that implements the above functions, in a computer readable manner, and by reading and executing the program code recorded in the recording medium with the computer (or CPU and MPU).

The recording medium can be, for example, a tape system such as a magnetic tape or a cassette tape, a disc system including a magnetic disc such as a floppy (registered trademark) disc/hard disc and an optical disc such as CD-ROM/MO/MD/DVD/CD-R, a card system such as an IC card (including a memory card)/optical card, or a semiconductor memory system such as a mask ROM/EPROM/EEPROM/flash ROM.

A portable terminal or a stationary apparatus may be configured to be connectable to a communication network and the program code may be supplied through the communication network. This communication network is not particularly limited and is available as the Internet, an intranet, an extranet, a LAN, an ISDN, a VAN, a CATV communication network, a virtual private network, a telephone line network, a mobile communication network, and a satellite communication network, for example. A transmitting medium making up the communication network is not particularly limited and is available as a wired medium such as IEEE 1394, USB, a power-line carrier, a cable TV line, a telephone line, and an ADSL line or a wireless medium such as infrared light in the case of IrDA or a remote controller, Bluetooth (registered trademark), 802.11 wireless transmission, HDR, a portable telephone network, a satellite line, and a digital terrestrial network, for example. The present invention is also implemented in a form of a computer data signal (transmitting medium) that realizes the program code through electronic transmission and that is embedded in a carrier wave.

### INDUSTRIAL AVAILABILITY

A reproducing apparatus (editing apparatus) of the present invention is preferably utilized for a video recorder, etc.

1. A content reproducing apparatus in a content reproducing system configured by connecting a server apparatus and a plurality of content reproducing apparatuses performing synchronous reproduction of content data and relevant information related to the content data to a network, comprising:
a portion that receives viewable segment information transmitted from the server apparatus, the viewable segment information indicating a viewable content reproduction position in another content reproducing apparatus for content data recorded in the another content reproducing apparatus;
a relevant information adding portion that when adding relevant information to recorded content data at a predetermined position, adds relevant information based on specified addition segment information corresponding to the position; and
an assessing portion that assesses appropriateness of adding the relevant information to the content data at the position based on the specified addition segment information and the received viewable segment information.

2. The content reproducing apparatus as defined in claim 1, comprising a portion that transmits viewable segment information indicative of a viewable content reproduction position of recorded content data to the server apparatus.

3. The content reproducing apparatus as defined in claim 1, wherein the addition of the relevant information is performed if assessed as appropriate, and wherein a screen is displayed that inquires whether it is necessary to add the relevant information if assessed as inappropriate.

4. The content reproducing apparatus as defined in claim 1, wherein if assessed as appropriate, alternative segment information is retrieved that includes viewable position information of the recorded content data assessed appropriate for adding the relevant information based on the received viewable segment information.

5. The content reproducing apparatus as defined in claim 4, wherein the retrieved alternative segment information is displayed.

6. The content reproducing apparatus as defined in claim 4, wherein based on the retrieved alternative segment information, the relevant information is added by relating to the alternative segment information.

7. The content reproducing apparatus as defined in claim 1, wherein the viewable segment information includes user ID information that identifies a user of a content reproducing apparatus with the viewable segment information set and wherein the appropriateness is assessed based on the user ID information.

8. A content editing apparatus in a content reproducing system configured by connecting a server apparatus and a plurality of content reproducing apparatuses reproducing content data to a network, comprising:
an editing portion that edits content data based on edition segment information specified when editing the content data recorded in the content editing apparatus;
a portion that receives relevant information addition segment information specified when relevant information is added to content data recorded in another content reproducing apparatus and transmitted from the server apparatus; and
a portion that assesses appropriateness of editing the content data based on the received relevant information addition segment information and the edition segment information specified when editing content data recorded in the content editing apparatus.

9. The content editing apparatus as defined in claim 8, comprising a portion that transmits relevant information addition segment information specified when adding relevant information to the content data to the server apparatus.

10. The content editing apparatus as defined in claim 8, wherein the editing includes a skip reproduction processing of the content data, a deleting processing, and processing for adding continuation content data to the content data.

11. The content editing apparatus as defined in claim 8, wherein the editing is performed if assessed as appropriate, and wherein a screen is displayed that inquires whether it is necessary to perform the editing if assessed as inappropriate.

12. The content editing apparatus as defined in claim 8, wherein if assessed as appropriate, alternative segment information that includes position information of the recorded content data assessed appropriate for performing the editing is retrieved based on the received relevant information segment information.

13. The content editing apparatus as defined in claim 12, wherein the retrieved alternative segment information is displayed.

14. The content editing apparatus as defined in claim 12, wherein based on the retrieved alternative segment information, the editing is performed by relating to the alternative segment information.

15. The content editing apparatus as defined in claim 8, wherein when performing a skip reproduction editing of content data, the editing portion stores specified edition segment information, assesses appropriateness of canceling the skip reproduction editing of the content data based on the received relevant information addition segment information and the stored edition segment information, and erases the stored edition segment information if assessed as appropriate.

16. The content editing apparatus as defined in claim 8, wherein the relevant information includes at least one of evaluation information of importance of the relevant information, user ID information identifying a user adding the relevant information, and time information of the addition of the relevant information, and wherein the appropriateness is assessed based on any one of the pieces of the information.

17. A server apparatus in a content reproducing system configured by connecting the server apparatus and a plurality of content reproducing apparatuses performing synchronous reproduction of content data and relevant information related to the content data to a network, comprising:
a portion that receives viewable segment information indicating a viewable content reproduction position of recorded content data transmitted from the content reproducing apparatuses, and/or a portion that receives the relevant information and relevant information addition segment information specified when the relevant information is added if relevant information is added to the content data, and
recording the received viewable segment information, the relevant information, and the addition segment information and transmitting the viewable segment information, the relevant information, and the addition segment information in accordance with a request from the content reproducing apparatuses.

18. A server apparatus in a content editing system configured by connecting the server apparatus and a plurality of content editing apparatuses editing content data to a network, comprising:
a portion that receives relevant information transmitted from the content editing apparatuses when relevant information is added to the content data in the content editing apparatuses and relevant information addition segment information specified when the relevant information is added, and
recording the received relevant information and the addition segment information and transmitting the relevant information and the addition segment information in accordance with a request from the content editing apparatuses.

19. A content reproducing system comprising the content reproducing apparatuses as defined in claim 1.

20. A content editing system comprising the content editing apparatuses as defined in claim 8.

21. A content reproducing method executed by a content reproducing apparatus in a content reproducing system configured by connecting a server apparatus and a plurality of content reproducing apparatuses performing synchronous reproduction of content data and relevant information related to the content data to a network, comprising the steps of:
receiving viewable segment information transmitted from the server apparatus, wherein the viewable segment information indicates a viewable content reproduction position in another content reproducing apparatus for content data recorded in the another content reproducing apparatus;
adding relevant information based on specified addition segment information when adding relevant information to recorded content data at a predetermined position, wherein the addition segment information corresponds to the position; and
assessing appropriateness of adding the relevant information to the content data at the position based on the specified addition segment information and the received viewable segment information.

22. A content editing method executed by a content editing apparatus in a content reproducing system configured by connecting a server apparatus and a plurality of content reproducing apparatuses reproducing content data to a network, comprising the steps of:
receiving relevant information addition segment information transmitted from the server apparatus, wherein the relevant information addition segment information is specified when relevant information is added to content data recorded in another content reproducing apparatus; and
assessing appropriateness of editing the content data based on the received relevant information addition segment information and edition segment information specified when editing content data recorded in the content editing apparatus.

23. A program operable to drive a computer to execute the content reproducing method as defined in claim 21.

24. A program operable to drive a computer to execute the content editing method as defined in claim 22.

25. A recording medium having the program as defined in claim 23 recorded thereon in a computer readable manner.

26. A content reproducing system comprising the server apparatus as defined in claim 17.

27. A content editing system comprising the server apparatus as defined in claim 18.

28. A recording medium having the program as defined in claim 24 recorded thereon in a computer readable manner.
